(19) United States
(12) Patent Application Publication
(10) Pub. No.: US 2025/0306886 A1
(43) Pub. Date: Oct. 2, 2025

(54) METHOD FOR DEVELOPING PLATFORM-INDEPENDENT CLOUD APPLICATIONS WITH A FLEXIBLE DEPLOYMENT MODEL AND AUTOMATED DEPLOYMENT

(71) Applicant: Defang Software Labs, Inc, Woodinville, WA (US)

(72) Inventors: Prakash Sundaresan, Point Roberts, WA (US); Lionello Lunesu, Vancouver (CA); Antoine Cote, Hong Kong (CN)

(21) Appl. No.: 19/060,671

(22) Filed: Feb. 22, 2025

Related U.S. Application Data
(60) Provisional application No. 63/570,720, filed on Mar. 27, 2024.

(51) Int. Cl. G06F 8/61; H04L 67/02; H04L 67/63

(52) U.S. Cl. CPC G06F 8/61; H04L 67/02; H04L 67/63

(57) ABSTRACT

A method for developing a platform-independent cloud application with a flexible deployment model and performing automated deployment on a target cloud platform is fulfilled in the ongoing description by (i) obtaining user-written application source code targeted to a Logical Application Model, (ii) obtaining from the user an Application Manifest that is agnostic to specific deployment models and target clouds, (iii) combining the user-written application source code with system-generated bindings and a main file to obtain a final application source code, (iv) dynamically determining based on heuristics or user-provided preferences, the optimal deployment model for each specific component of the cloud application, (v) transforming the Application Manifest into a deployment configuration file based on the optimal deployment model and the target cloud platform, (vi) automatically generating IaC scripts based on the deployment configuration file, and (vii) automatically deploying executable components of the cloud application on the target cloud platform.

### BACKGROUND

### Technical Field

The embodiments herein generally relate to cloud software applications, and more particularly, to a method for developing platform-independent cloud applications with a flexible deployment model and automated deployment.

### Description of the Related Art

Over the last 15 years, cloud platforms have become the de-facto target for developing and deploying a large class of software applications collectively referred to here as “cloud applications”. The cloud applications include the “back-ends” for the vast majority of mobile or web-based apps that consumers use in their daily lives (such as ride-sharing, e-commerce, travel, etc.), as well as a broad range of enterprise applications used by people at work (such as analytics, communication, security, etc.), as well as emerging AI-based applications. The advent and prevalence of cloud platforms have brought significant advantages to the customer, chief among them being eliminating the need for the cloud application developer to (a) set-up their hardware in one or more data-centers, (b) provision capacity for peak workloads, and (c) providing for resiliency through redundancy of the hardware at local, regional, and global levels.

However, the advent of cloud computing has also brought forward a new set of technical challenges for the cloud application developer. Because, various cloud platforms differ in the specifics of the services they provide (such as compute, storage, databases, networking, security, etc.). It is very cumbersome for the cloud application developer to write an application that can run on multiple cloud platforms without making significant code changes.

Further, cloud application logic is typically written to run in one out of a selection of computation models such as a function-as-a-service (FaaS), a container-as-as-service (CaaS), or a virtual-machine-as-a-service (VMaaS) and it is not easy to change the computation model at the time of application deployment. Since it is difficult to determine the optimal computation model for an application or a component of the application a-priori, changing the deployment model typically requires rewriting the application code.

Furthermore, in order for the cloud application developer to deploy the cloud application to a selected target cloud platform, it is required of the cloud application developer to learn a whole new skill set of writing deployment scripts (commonly referred to as Infrastructure-as-Code or IaC), which include deploying not only the components of the cloud application, but also (a) configuring and securing the cloud services used by the cloud application, (b) configuring networking and load balancing, and (c) optimizing scaling, performance, cost, etc. As most cloud application developers are not experts in these deployment matters, it results in errors that incur huge time and resources later on.

Accordingly, there exists a need to address the aforementioned technical problems by providing an easy way for cloud application developers to develop platform-independent cloud applications that can be deployed to one of multiple cloud platforms with no code changes along with a flexible deployment model where application components can be deployed on a choice of FaaS, CaaS, or VMaaS models with no code changes, and automated deployment to a target cloud platform.

### SUMMARY

In view of the foregoing, embodiments herein provide a processor-implemented method for developing a platform-independent cloud application with a flexible deployment model and performing automated deployment on a target cloud platform, the method comprising (i) obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model, (ii) obtaining, from a user device, an Application Manifest that is agnostic to specific deployment models and target clouds, wherein the Application Manifest comprises of a specification of the logical components within the cloud application and their relationships, (iii) combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings, (iv) dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS), (v) transforming the Application Manifest into a deployment configuration file based on the optimal deployment model and the target cloud platform, wherein logical names from the Application Manifest are consistently propagated into the deployment configuration file, (vi) automatically generating Infrastructure-as-Code (IaC) scripts based on the deployment configuration file, and (vii) automatically deploying, using the IaC scripts, executable components of the cloud application on the target cloud platform, wherein the executable components are based on the final application source code, the system-generated bindings, and the main file.

The method is of advantageous in that the method enables portability across cloud platforms by abstracting cloud-specific dependencies and integrating the Logical Application Model (LAM) that is independent of any particular cloud provider. Utilization of method-generated bindings enables application services to be dynamically linked to platform-specific implementations without requiring modifications to the user-written application source code. The same user-written application code can be deployed across different cloud environments, such as Amazon Web Services (AWS), Microsoft Azure, and Google Cloud Platform (GCP), without requiring cloud-specific adjustments. Additionally, by transforming the Application Manifest into a deployment configuration file that is agnostic to any particular cloud platform, the method eliminates vendor lock-in and enables multi-cloud deployment without additional development effort.

The method also provides deployment model flexibility by dynamically selecting the optimal deployment model between Function-as-a-Service (FaaS), Container-as-a-Service (CaaS), or Virtual-Machine-as-a-Service (VMaaS) for each component of the cloud application based on heuristics or user-provided preferences. This ensures that the application components are deployed using the most efficient model for performance, scalability, and cost-effectiveness. Furthermore, the method eliminates the need for developers to manually write Infrastructure-as-Code (IaC) scripts, as it automatically generates the required IaC configuration based on the deployment configuration file. Therefore, the method reduces the complexity associated with provisioning cloud infrastructure, mitigates the risk of configuration errors, and allows developers to focus on application logic rather than infrastructure setup.

In some embodiments, the deployment configuration file comprises deployment artifacts that include at least one of a FaaS function, a CaaS container or a VMaaS virtual machine.

In some embodiments, the deployment artifacts further include an instantiation of at least one of (a) an object store, (b) a database or (c) a queue used by the final application source code.

In some embodiments, the instantiation includes securely mapping credentials in the deployment configuration file to corresponding secure storage on the target cloud platform.

In some embodiments, mapping and routing calls to application endpoints specified in the Application Manifest to specific functions that implement the user-written application source code for the application endpoints based on the main file are included.

In some embodiments, the mapping further comprises associating HTTP methods and paths with API Gateway routes in the deployment configuration file.

In some embodiments, the executable components are generated by compiling the final application source code, the system-generated bindings, and the main file.

In another aspect, there is provided a system for developing a platform-independent cloud application with a flexible deployment model and performing automated deployment on a target cloud platform, comprising: a memory that stores a set of instructions; and a processor that is configured to execute the set of instructions for: (i) obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model, (ii) obtaining, from a user device, an Application Manifest that is agnostic to specific deployment models and target clouds, wherein the Application Manifest comprises of a specification of the logical components within the cloud application and their relationships, (iii) combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings, (iv) dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS), (v) transforming the Application Manifest into a deployment configuration file based on the optimal deployment model and the target cloud platform, wherein logical names from the Application Manifest are consistently propagated into the deployment configuration file, (vi) automatically generating Infrastructure-as-Code (IaC) scripts based on the deployment configuration file, and (vii) automatically deploying, using the IaC scripts, executable components of the cloud application on the target cloud platform, wherein the executable components are based on the final application source code, the system-generated bindings, and the main file.

The system is of advantageous in that the system enables portability across cloud platforms by abstracting cloud-specific dependencies and integrating the Logical Application Model (LAM) that is independent of any particular cloud provider. Utilization of system-generated bindings enables application services to be dynamically linked to platform-specific implementations without requiring modifications to the user-written application source code. The same user-written application code can be deployed across different cloud environments, such as AWS, Azure, and GCP, without requiring cloud-specific adjustments. Additionally, by transforming the Application Manifest into a deployment configuration file that is agnostic to any particular cloud platform, the system eliminates vendor lock-in and enables multi-cloud deployment without additional development effort.

The system also provides deployment model flexibility by dynamically selecting the optimal deployment model between Function-as-a-Service (FaaS), Container-as-a-Service (CaaS), or Virtual-Machine-as-a-Service (VMaaS) for each component of the cloud application based on heuristics or user-provided preferences. This ensures that the application components are deployed using the most efficient model for performance, scalability, and cost-effectiveness. Furthermore, the system eliminates the need for developers to manually write Infrastructure-as-Code (IaC) scripts, as it automatically generates the required IaC configuration based on the deployment configuration file. Therefore, the system reduces the complexity associated with provisioning cloud infrastructure, mitigates the risk of configuration errors, and allows developers to focus on application logic rather than infrastructure setup.

In some embodiments, the deployment configuration file comprises deployment artifacts that include at least one of a FaaS function, a CaaS container or a VMaaS virtual machine.

In some embodiments, the deployment artifacts further include an instantiation of at least one of (a) an object store, (b) a database or (c) a queue used by the final application source code.

In some embodiments, the instantiation includes credentials defined in the deployment configuration.

In some embodiments, mapping and routing calls to application endpoints specified in the Application Manifest to specific functions that implement the user-written application source code for the application endpoints based on the main file are included.

In some embodiments, the mapping further comprises associating HTTP methods and paths with API Gateway routes in the deployment configuration file.

In some embodiments, the executable components are generated by compiling the final application source code, the system-generated bindings, and the main file.

In yet another aspect, there is provided a non-transitory computer-readable storage medium storing a sequence of instructions, which when executed by one or more processors, causes developing a platform-independent cloud application with a flexible deployment model and performing automated deployment on a target cloud platform, comprising (i) obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model, (ii) obtaining, from a user device, an Application Manifest that is agnostic to specific deployment models and target clouds, wherein the Application Manifest comprises of a specification of the logical components within the cloud application and their relationships, (iii) combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings, (iv) dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS), (v) transforming the Application Manifest into a deployment configuration file based on the optimal deployment model and the target cloud platform, wherein logical names from the Application Manifest are consistently propagated into the deployment configuration file, (vi) automatically generating Infrastructure-as-Code (IaC) scripts based on the deployment configuration file, and (vii) automatically deploying, using the IaC scripts, executable components of the cloud application on the target cloud platform, wherein the executable components are based on the final application source code, the system-generated bindings, and the main file.

In some embodiments, the deployment configuration file comprises deployment artifacts that include at least one of a FaaS function, a CaaS container or a VMaaS virtual machine.

In some embodiments, the deployment artifacts further include an instantiation of at least one of (a) an object store, (b) a database or (c) a queue used by the final application source code.

In some embodiments, the instantiation includes credentials defined in the deployment configuration.

In some embodiments, mapping and routing calls to application endpoints specified in the Application Manifest to specific functions that implement the user-written application source code for the application endpoints based on the main file are included.

In some embodiments, the mapping further comprises associating HTTP methods and paths with API Gateway routes in the deployment configuration file.

In some embodiments, the executable components are generated by compiling the final application source code, the system-generated bindings, and the main file.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system for developing a platform-independent cloud application with a flexible deployment model and automatically deploying on a target cloud platform according to some embodiments herein;

FIG. 2 illustrates an exploded view of a platform independent and flexible application deployment server of FIG. 1 according to some embodiments herein;

FIGS. 3A-D illustrates the final application source code generated upon receiving a deployment command for a target cloud platform according to some embodiments herein;

FIG. 4 illustrates a process flow of different user personas for developing a platform-independent cloud application with a flexible deployment model and automatically deploying on a target cloud platform according to some embodiments herein;

FIGS. 5A-B is a flow diagram that illustrates a method for developing a platform-independent cloud application with a flexible deployment model and automatically deploying on a target cloud platform according to some embodiments herein;

FIG. 6 is a representative cloud computing environment for practicing the embodiments herein; and

FIG. 7 is a representative hardware environment for practicing the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the view of the foregoing, developing a platform-independent cloud application with a flexible deployment model and automatically deploying to a target cloud platform is fulfilled in the ongoing description by (i) obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model; (ii) obtaining, from a user device, an Application Manifest that is agnostic to specific deployment models and target clouds, wherein the Application Manifest comprises of a specification of the logical components within the cloud application and their relationships; (iii) combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings; (iv) dynamically determining, based on at least one of heuristics or user-provided preferences, the optimal deployment model for each specific component of the cloud application, wherein the optimal deployment model is selected from one of function-as-a-service (FaaS), CaaS, or VMaaS; (v) transforming the Application Manifest into a deployment configuration file based on the optimal deployment model and the target cloud platform; (vi) automatically generating IaC scripts based on the deployment configuration file; and (vii) automatically deploying, using the IaC scripts, executable components of the cloud application on the target cloud platform, wherein the executable components are based on the final application source code, the system-generated bindings, and the main file.

The term “user-written application source code” refers to user-created set of instructions written in a programming language, defining the functionality and behavior of a cloud application.

The term “Logical Application Model” refers to a framework that abstracts the underlying cloud infrastructure, allowing the cloud application to be portable across various target cloud platforms without code modification.

The term “Logical Name” refers to an identifier assigned to an application component, service, or resource within the user-written application source code or the Logical Application Model.

The term “system-generated bindings” refers to automatically created connections or mappings that link calls to generic services within the user-written application source code to specific instances or implementations on the target cloud platform.

The term “final application source code” refers to compiled or assembled version of the user-written application source code, after integration with system-generated bindings and additional components, ready for deployment.

The term “optimal deployment model” refers to a suitable configuration (from FaaS, CaaS, or VMaaS) for deploying each specific component of the cloud application that is determined based on factors such as resource requirements, performance considerations, and user preferences.

The term “Application Manifest” refers to a specification of the logical components within the cloud application and their relationships, independent of the specific deployment model or target cloud platform.

The term “deployment configuration file” refers to a file containing instructions and parameters defining how the cloud application should be deployed, including, but not limited to, specifications for the target cloud platform, and the deployment model (FaaS, CaaS, or VMaaS) for each specific application component.

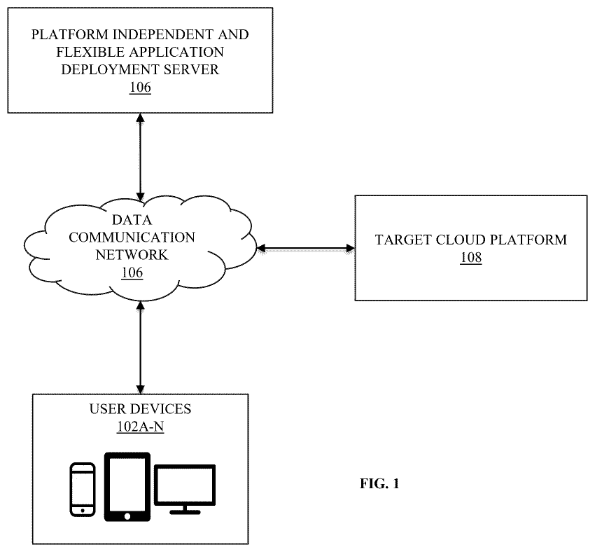

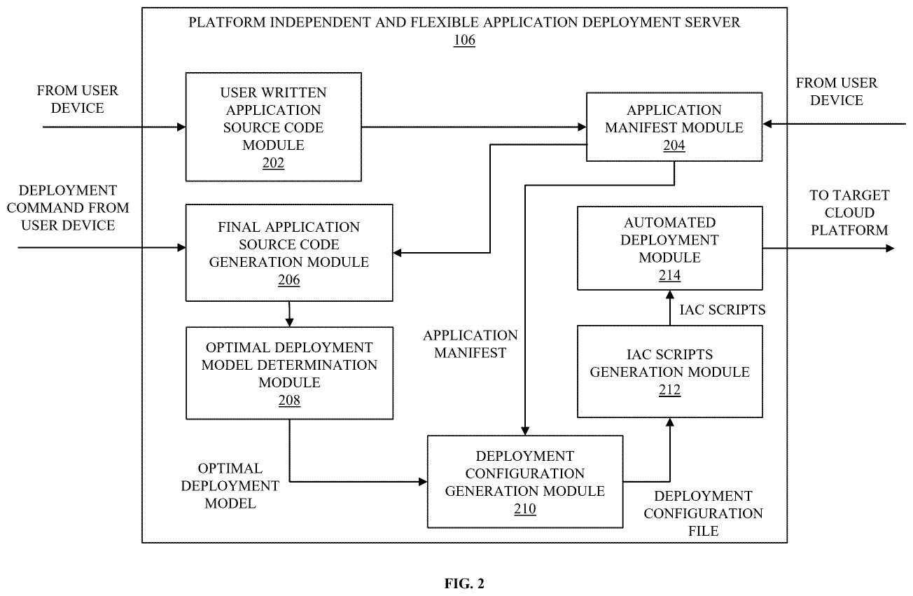

FIG. 1 illustrates a system for developing a platform-independent cloud application with a flexible deployment model and automatically deploying on a target cloud platform according to some embodiments herein. The system includes one or more user devices 102A-N, a data communication network 104, a platform independent and flexible application deployment server 106 and a target cloud platform 108. The one or more devices 102A-N are communicatively connected to the platform independent and flexible application deployment server 106 via the data communication network 104. The platform independent and flexible application deployment server 106 is communicatively connected to the target cloud platform 108.

The data communication network 104 may be one or more of a wired network, a wireless network, a combination of the wired network and the wireless network, or the Internet. The one or more devices 102A-N include but are not limited to, a mobile device, a smartphone, a smartwatch, a notebook, a Global Positioning System (GPS) device, a tablet, a desktop computer, a laptop, or any network-enabled device.

The platform independent and flexible application deployment server 106 obtains, from a user device 102A, user-written application source code that includes functions and calls to generic application programming services. The user-written application source code is targeted to a Logical Application Model (LAM) that is independent of (a) a particular choice of cloud platform 108 and (b) a particular choice of deployment model. The platform independent and flexible application deployment server 106 obtains, from the user device 102A, an Application Manifest that is agnostic to specific deployment models and target clouds. The Application Manifest comprises of a specification of the logical components within the cloud application and their relationships.

The platform independent and flexible application deployment server 106, upon receiving from the user device 102A a deployment command that includes an identifier of the target cloud platform 108, combines the user-written application source code with system-generated bindings and a main file to obtain a final application source code. The generic services in the user-written application code are bound to specific instances of services on the target cloud platform 108 using the system-generated bindings. The platform independent and flexible application deployment server 106 dynamically determines, based on one or more of heuristics or user-provided preferences, the optimal deployment model for each specific component of the cloud application, The optimal deployment model is selected from one of FaaS, CaaS, or VMaaS.

The platform independent and flexible application deployment server 106 transforms the Application Manifest into a deployment configuration file based on the optimal deployment model and the target cloud platform 108. Logical names from the Application Manifest are consistently propagated into the deployment configuration file. The platform independent and flexible application deployment server 106 automatically generates IaC scripts based on the deployment configuration file. The platform independent and flexible application deployment server 106 automatically deploys, using the IaC scripts, executable components of the cloud application on the target cloud platform 108. The executable components are based on the final application source code, the system-generated bindings, and the main file.

The system is of advantageous in that the system enables portability across cloud platforms by abstracting cloud-specific dependencies and integrating the Logical Application Model (LAM) that is independent of any particular cloud provider. Utilization of system-generated bindings enables application services to be dynamically linked to platform-specific implementations without requiring modifications to the user-written application source code. The same user-written application code can be deployed across different cloud environments, such as Amazon Web Services (AWS), Microsoft Azure, and Google Cloud Platform (GCP), without requiring cloud-specific adjustments. Additionally, by transforming the Application Manifest into a deployment configuration file that is agnostic to any particular cloud platform, the system eliminates vendor lock-in and enables multi-cloud deployment without additional development effort.

The system also provides deployment model flexibility by dynamically selecting the optimal deployment model between Function-as-a-Service (FaaS), Container-as-a-Service (CaaS), or Virtual-Machine-as-a-Service (VMaaS) for each component of the cloud application based on heuristics or user-provided preferences. This ensures that the application components are deployed using the most efficient model for performance, scalability, and cost-effectiveness. Furthermore, the system eliminates the need for developers to manually write Infrastructure-as-Code (IaC) scripts, as it automatically generates the required IaC configuration based on the deployment configuration file. Therefore, the system reduces the complexity associated with provisioning cloud infrastructure, mitigates the risk of configuration errors, and allows developers to focus on application logic rather than infrastructure setup.

FIG. 2 illustrates an exploded view of the platform independent and flexible application deployment server 106 of FIG. 1 according to some embodiments herein. The platform independent and flexible application deployment server 106 includes a user-written application source code module 202, an Application Manifest module 204, a final application source code generation module 206, an optimal deployment model determination module 208, a deployment configuration generation module 210, an IaC scripts generation module 212, and an automated deployment module 214.

The user-written application source code module 202 obtains, from a user device 102A, user-written application source code that includes functions and calls to generic application programming services. The user-written application source code is targeted to a Logical Application Model (LAM) that is independent of (a) a particular choice of cloud platform 108 and (b) a particular choice of deployment model. The Application Manifest module 204 obtains, from the user device 102A, an Application Manifest that is agnostic to specific deployment models and the target cloud platforms. The Application Manifest comprises a specification of the logical components within the cloud application and their relationships.

The LAM provides a logical abstraction of a cloud platform that is independent of the underlying target cloud platform as well as independent of a chosen deployment model and can be deployed to any of a given set of target cloud platforms.

The final application source code generation module 206 combines the user-written application source code with system-generated bindings and a main file to obtain a final application source code upon receiving from the user device 102A a deployment command that includes an identifier of the target cloud platform 108. The generic services in the user-written application code are bound to specific instances of services on the target cloud platform 108 using the system-generated bindings. The final application source code generation module 206 parses the application manifest file, decides on a physical infrastructure based on heuristics, creates a “compose.yml” file with physical infrastructure pieces, creates bindings code to map logical names to physical resources and creates envelope “main” with app-wide initialization code.

The optimal deployment model determination module 208 dynamically determines, based on one or more of heuristics or user-provided preferences, the optimal deployment model for each specific component of the cloud application, The optimal deployment model is selected from one of function-as-a-service (FaaS), container-as-a-service (CaaS), or Virtual-Machine-as-a-Service (VMaaS).

The deployment configuration generation module 210 transforms the Application Manifest into a deployment configuration file based on the optimal deployment model and the target cloud platform 108. Logical names from the Application Manifest are consistently propagated into the deployment configuration file. The IaC scripts generation module 212 automatically generates Infrastructure-as-Code (IaC) scripts based on the deployment configuration file. Transforming the Application Manifest into the deployment configuration file may include mapping functions to FaaS components, such as AWS Lambda.

The automated deployment module 214 automatically deploys, using the IaC scripts, executable components of the cloud application on the target cloud platform 108. The executable components are based on the final application source code, the system-generated bindings, and the main file. In some embodiments, at build and/or deployment time, the application developer specifies the target cloud platform. The platform independent and flexible application deployment server 106 parses the Application Manifest and translates the logical artifacts specified in the Application Manifest into a compose file. The compose file is a way to specify the physical components to be deployed to the target cloud platform. For example, the translation maps each ServiceMethod specified in the Application Manifest to an appropriate implementation (either as a FaaS function or an endpoint in a container to be deployed on a CaaS service). The translation further automatically maps logical resources (such as a database or an object store) to a corresponding physical resource (RDS and S3 respectively on AWS). Further, the compose file automatically generates specifications for additional requirements such as API gateways, networking, port bindings, secret stores, etc.

The platform independent and flexible application deployment server 106 further generates additional artifacts such as a main.go and a bindings file that are needed to link the cloud application correctly so that the ServiceMethod invocations are routed to the corresponding function definitions. Finally, the platform independent and flexible application deployment server 106 compiles the source application, along with the generated artifacts such as the main.go and bindings file and then deploys them to the target cloud platform.

In some embodiments, the deployment configuration file comprises deployment artifacts that include at least one of a FaaS function, a CaaS container or a VMaaS virtual machine. The deployment configuration file may include a mapping of a logical component “key-value store” to a corresponding database implementation on the target cloud platform.

In some embodiments, the deployment artifacts further include at least one of an instantiation of an object store, a database or a queue used by the final application source code.

In some embodiments, the platform independent and flexible application deployment server 106 maps and routes calls to application endpoints specified in the Application Manifest description of logical components of the cloud application with specific functions that implement the user-written application source code for the application endpoints based on the main file.

In some embodiments, the executable components are generated by compiling the final application source code, the system-generated bindings, and the main file.

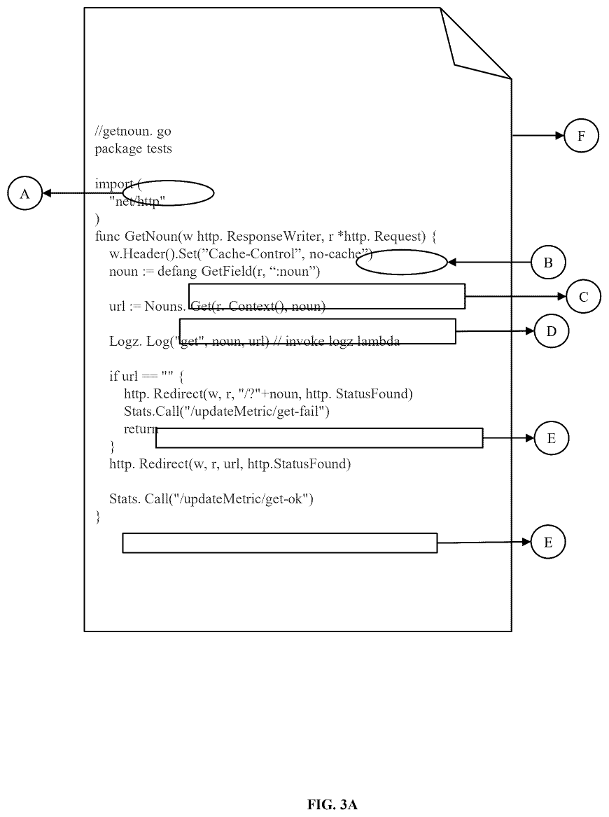

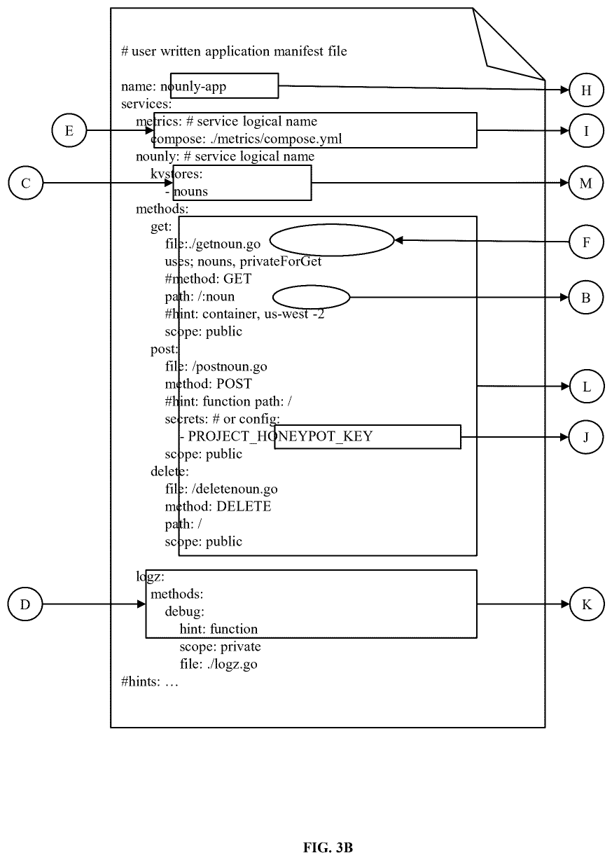

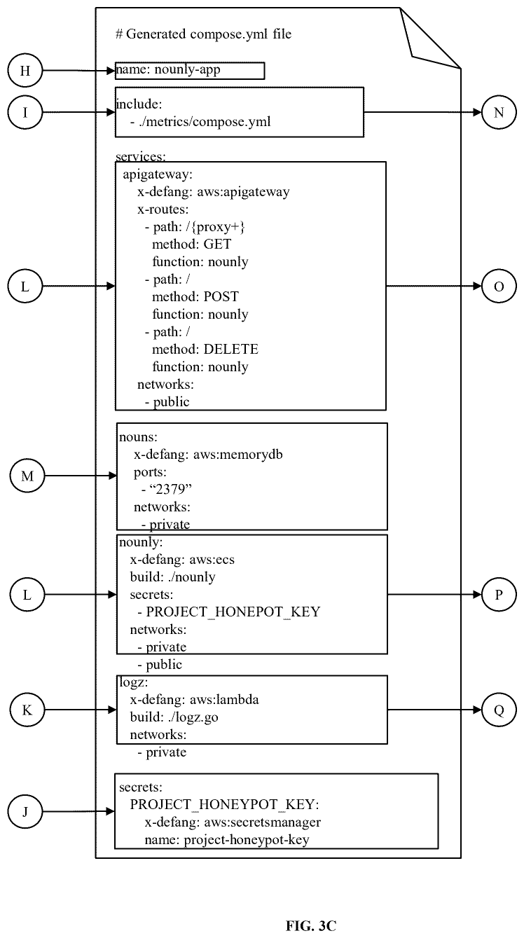

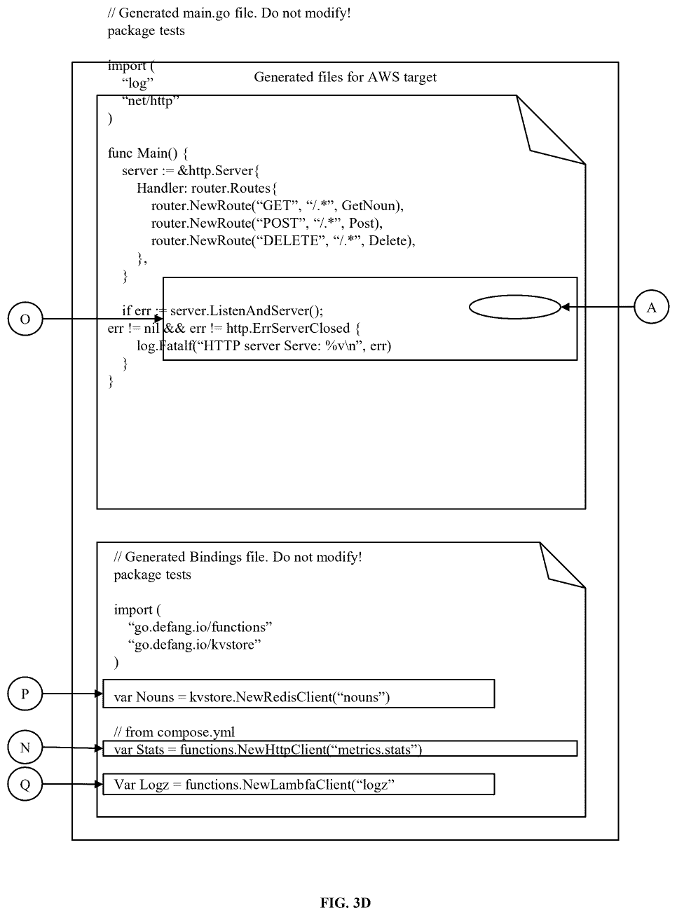

FIGS. 3A-D illustrates the final application source code generated upon receiving a deployment command for a target cloud platform according to some embodiments herein. The figure depicts various components such as user-written application source code (getnoun.go), a mock bindings file (bindings.go) for development, a user-written application manifest file, a generated deployment configuration file (compose.yml), and the set of generated files (main.go, bindings file) specific to the AWS target platform. The figure further demonstrates how different code components are processed, transformed, and mapped to various cloud infrastructure elements during the deployment process.

The figure shows the automatic mapping and transformation of application components across different stages of deployment and shows the linkages between the user-written application source code and the generated deployment artifacts.

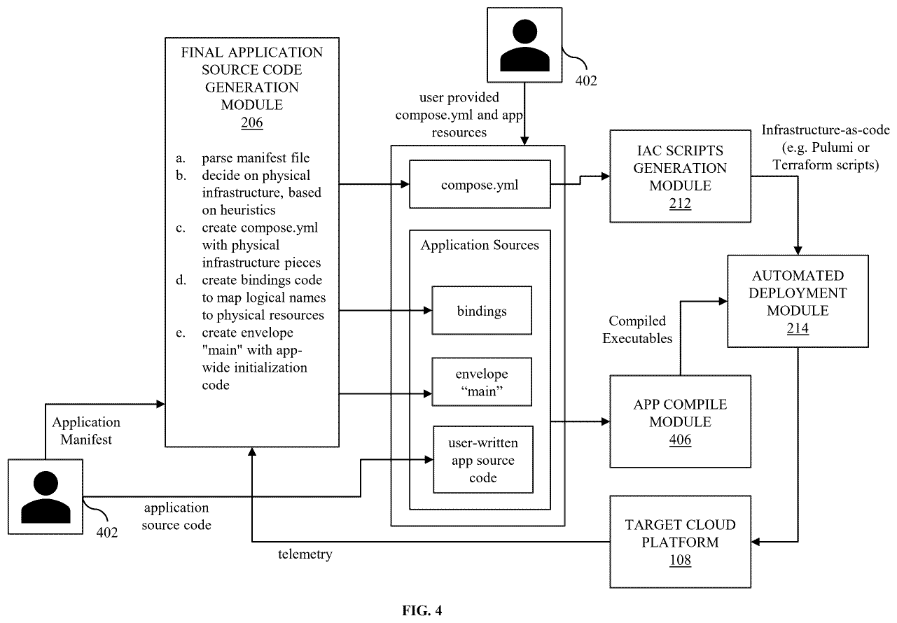

FIG. 4 illustrates a process flow of different user personas for developing a platform-independent cloud application with a flexible deployment model and automatically deploying on a target cloud platform according to some embodiments herein. The process flow depicts a developer persona 402, a final application source code generation module 206, an IAC scripts generation module 212, an automated deployment module 214, an application compile module 406 and a target cloud platform 108.

The developer persona 402 provides the application manifest to the final application source code generation module 206 and also provides an application source code. The developer persona 402 provides the compose.yml and application resources.

As the compose.yml and application sources are obtained via the developer persona 402, the application compile module 406 generates compiled executables and the IAC scripts generation module 212 generates infrastructure-as-code scripts for the automated deployment module 214. The automated deployment module 214 automatically deploys the executable components of the cloud application on the target cloud platform 108 using the IaC scripts.

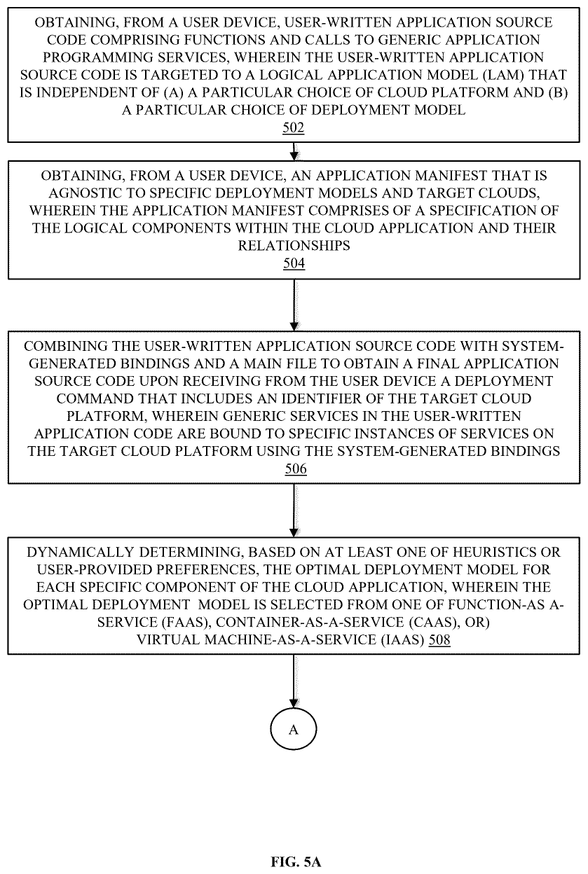

FIGS. 5A-B is a flow diagram that illustrates a method for developing a platform-independent cloud application with a flexible deployment model and automatically deploying on a target cloud platform according to some embodiments herein. At step 502, the method includes obtaining, from a user device, user-written application source code comprising functions and calls to generic application programming services. The user-written application source code is targeted to a Logical Application Model (LAM) that is independent of (a) a particular choice of cloud platform and (b) a particular choice of deployment model. At step 504, the method includes obtaining, from a user device, an Application Manifest that is agnostic to specific deployment models and target clouds. The Application Manifest comprises a specification of the logical components within the cloud application and their relationships. At step 506, the method includes combining the user-written application source code with system-generated bindings and a main file to obtain a final application source code upon receiving from the user device a deployment command that includes an identifier of the target cloud platform. Generic services in the user-written application code are bound to specific instances of services on the target cloud platform using the system-generated bindings. At step 508, the method includes dynamically determining, based on at least one of heuristics or user-provided preferences, the optimal deployment model for each specific component of the cloud application. The optimal deployment model is selected from one of function-as-a-service (FaaS), container-as-a-service (CaaS), or Virtual-Machine-as-a-service (VMaaS). At step 510, the method includes transforming the Application Manifest into a deployment configuration file based on the optimal deployment model and the target cloud platform. Logical names from the Application Manifest are consistently propagated into the deployment configuration file. At step 512, the method includes automatically generating Infrastructure-as-Code (IaC) scripts based on the deployment configuration file. At step 514, the method includes automatically deploying, using the IaC scripts, executable components of the cloud application on the target cloud platform. The executable components are based on the final application source code, the system-generated bindings, and the main file.

The method is of advantageous in that the method enables portability across cloud platforms by abstracting cloud-specific dependencies and integrating the Logical Application Model (LAM) that is independent of any particular cloud provider. Utilization of method-generated bindings enables application services to be dynamically linked to platform-specific implementations without requiring modifications to the user-written application source code. The same user-written application code can be deployed across different cloud environments, such as AWS, Azure, and GCP, without requiring cloud-specific adjustments. Additionally, by transforming the Application Manifest into a deployment configuration file that is agnostic to any particular cloud platform, the method eliminates vendor lock-in and enables multi-cloud deployment without additional development effort.

The method also provides deployment model flexibility by dynamically selecting the optimal deployment model between Function-as-a-Service (FaaS), Container-as-a-Service (CaaS), or Virtual-Machine-as-a-Service (VMaaS) for each component of the cloud application based on heuristics or user-provided preferences. This ensures that the application components are deployed using the most efficient model for performance, scalability, and cost-effectiveness. Furthermore, the method eliminates the need for developers to manually write Infrastructure-as-Code (IaC) scripts, as it automatically generates the required IaC configuration based on the deployment configuration file. Therefore, the method reduces the complexity associated with provisioning cloud infrastructure, mitigates the risk of configuration errors, and allows developers to focus on application logic rather than infrastructure setup.

In some embodiments, the deployment configuration file comprises deployment artifacts that include at least one of a FaaS function, a CaaS container or a VMaaS virtual machine.

In some embodiments, the deployment artifacts further include at least one of an instantiation of an object store, a database or a queue used by the final application source code.

In some embodiments, the server mapping and routing calls to application endpoints specified in the Application Manifest description of logical components of the cloud application with specific functions that implement the user-written application source code for the application endpoints based on the main file.

In some embodiments, the executable components are generated by compiling the final application source code, the system-generated bindings, and the main file.

The various systems and corresponding components described herein and/or illustrated in the figures may be embodied or utilized in different cloud computing environments, including a distributed data processing environment or distributed computing environments. It is to be understood that although a detailed description of a cloud computing environment is provided, implementation of the teachings provided herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service. A cloud computing environment is service oriented with a focus on statelessness, low coupling, modularity, and semantic interoperability. Essentially, cloud computing is an infrastructure that includes a network of interconnected nodes. As an example, a cloud computing environment may include one or more cloud computing nodes with which local computing devices used by cloud consumers, such as, for example, cellular telephone, desktop computer, laptop computer, and/or automobile computer system may communicate. The one or more cloud computing nodes may communicate with one another and may be grouped physically or virtually, in one or more networks, such as private, community, public, or hybrid clouds as described hereinabove, or a combination thereof. This allows the cloud computing environment to offer infrastructure, platforms and/or software as services for which a cloud consumer does not need to maintain resources on a local computing device. It is understood that one or more cloud computing nodes and the cloud computing environment can communicate with any type of computerized device over any type of network and/or network addressable connection, e.g., using a web browser.

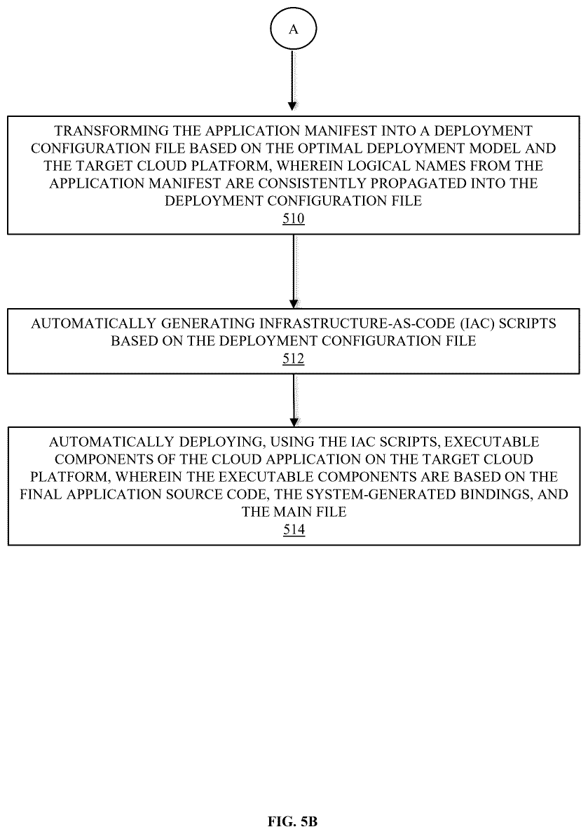

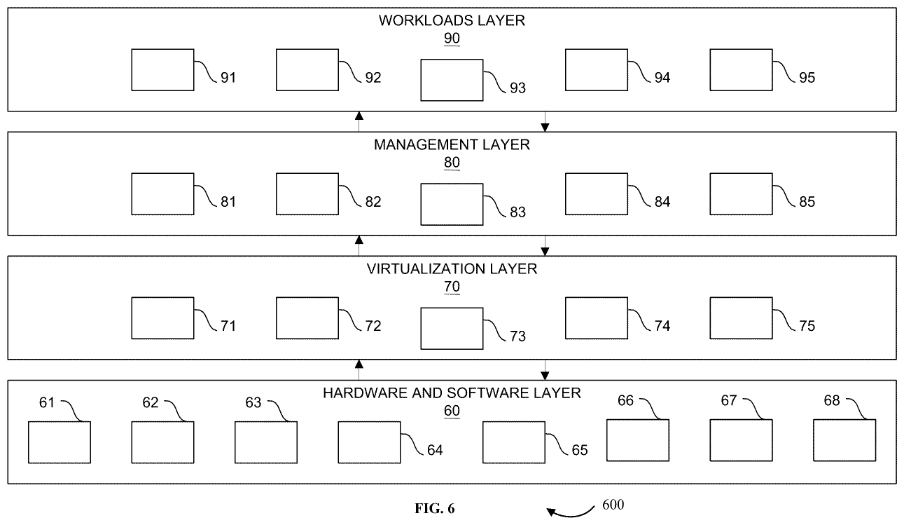

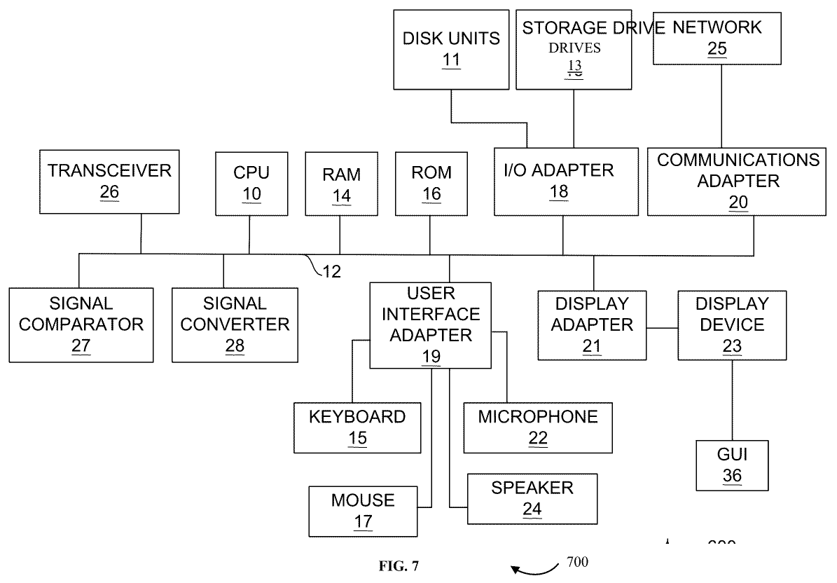

Referring now to FIG. 6, a representative cloud computing environment 600 comprising a set of functional abstraction layers are shown. It should be understood in advance that the components, layers, and functions shown in FIG. 7 are intended to be illustrative only and embodiments of the invention are not limited thereto. As depicted, the following layers and corresponding functions are provided. A hardware and software layer 60 includes hardware and software components. Examples of hardware components include mainframes 61, RISC (Reduced Instruction Set Computer) architecture based servers 62, servers 63, blade servers 64, storage devices 65, and networks and networking components 66. In some embodiments, software components include network application server software 67 and database software 68. A virtualization layer 70 provides an abstraction layer from which the following examples of virtual entities may be provided virtual servers 71, virtual storage 72, virtual networks 73, including virtual private networks, virtual applications and operating systems 74, and virtual clients 75.

In one example, management layer 80 may provide the functions described below. Resource provisioning 81 provides dynamic procurement of computing resources and other resources that are utilized to perform tasks within the cloud computing environment 600. Metering and pricing 82 provide cost tracking as resources are utilized within the cloud computing environment 600, and billing or invoicing for consumption of these resources. In one example, these resources may include application software licenses. Security provides identity verification for cloud consumers and tasks, as well as protection for data and other resources. User portal 83 provides access to the cloud computing environment 600 for consumers and system administrators. Service level management 84 provides cloud computing resource allocation and management such that required service levels are met.

Workloads layer 90 provides examples of functionality for which the cloud computing environment 600 may be utilized. Examples of workloads and functions which may be provided from this layer include mapping and navigation 91, software development and lifecycle management 92, virtual classroom education delivery 93, data analytics processing 94, transaction processing 95, and microservice recipe creation 96.

The embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM) and, a rigid magnetic disk.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

A representative hardware environment for practicing the embodiments herein is depicted in FIG. 7, with reference to FIGS. 1 through 6. This schematic drawing illustrates a hardware configuration of a software development device/computer system 700 in accordance with the embodiments herein. The system includes at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system 700 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A processor-implemented method for developing a platform-independent cloud application with a flexible deployment model and performing automated deployment on a target cloud platform, the method comprising:
obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model;
obtaining, from a user device, an Application Manifest that is agnostic to specific deployment models and target clouds, wherein the Application Manifest comprises of a specification of the logical components within the cloud application and their relationships;
combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings;
dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS);
transforming the Application Manifest into a deployment configuration file based on the optimal deployment model and the target cloud platform, wherein logical names from the Application Manifest are consistently propagated into the deployment configuration file;
automatically generating Infrastructure-as-Code (IaC) scripts based on the deployment configuration file; and
automatically deploying, using the IaC scripts, executable components of the cloud application on the target cloud platform, wherein the executable components are based on the final application source code, the system-generated bindings, and the main file.

2. The processor-implemented method of claim 1, wherein the deployment configuration file comprises deployment artifacts that include at least one of a FaaS function, a CaaS container or a VMaaS virtual machine.

3. The processor-implemented method of claim 2, wherein the deployment artifacts further include an instantiation of at least one of (a) an object store, (b) a database or (c) a queue used by the final application source code.

4. The processor-implemented method of claim 3, wherein the instantiation includes securely mapping credentials in the deployment configuration file to corresponding secure storage on the target cloud platform.

5. The processor-implemented method of claim 2, further comprising mapping and routing calls to application endpoints specified in the Application Manifest to specific functions that implement the user-written application source code for the application endpoints based on the main file.

6. The processor-implemented method of claim 5, wherein the mapping further comprises associating HTTP methods and paths with API Gateway routes in the deployment configuration file.

7. The processor-implemented method of claim 1, wherein the executable components are generated by compiling the final application source code, the system-generated bindings, and the main file.

8. A system for developing a platform-independent cloud application with a flexible deployment model and performing automated deployment on a target cloud platform, comprising:
a memory that stores a set of instructions; and
a processor that is configured to execute the set of instructions for:
obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model;
obtaining, from a user device, an Application Manifest that is agnostic to specific deployment models and target clouds, wherein the Application Manifest comprises of a specification of the logical components within the cloud application and their relationships;
combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings;
dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS);
transforming the Application Manifest into a deployment configuration file based on the optimal deployment model and the target cloud platform, wherein logical names from the Application Manifest are consistently propagated into the deployment configuration file;
automatically generating Infrastructure-as-Code (IaC) scripts based on the deployment configuration file; and
automatically deploying, using the IaC scripts, executable components of the cloud application on the target cloud platform, wherein the executable components are based on the final application source code, the system-generated bindings, and the main file.

9. The system of claim 8, wherein the deployment configuration file comprises deployment artifacts that include at least one of a FaaS function, a CaaS container or a VMaaS virtual machine.

10. The system of claim 9, wherein the deployment artifacts further include an instantiation of at least one of (a) an object store, (b) a database or (c) a queue used by the final application source code.

11. The system of claim 10, wherein the instantiation includes credentials defined in the deployment configuration.

12. The system of claim 9, wherein the processor further performs mapping and routing calls to application endpoints specified in the Application Manifest to specific functions that implement the user-written application source code for the application endpoints based on the main file.

13. The system of claim 12, wherein the mapping further comprises associating HTTP methods and paths with API Gateway routes in the deployment configuration file.

14. The system of claim 8, wherein the executables components are generated by compiling the final application source code, the system-generated bindings, and the main file.

15. A non-transitory computer-readable storage medium storing a sequence of instructions, which when executed by one or more processors, causes developing a platform-independent cloud application with a flexible deployment model and performing automated deployment on a target cloud platform, comprising:
obtaining, from a user device, user-written application source code comprising functions and calls to generic application programming services, wherein the user-written application source code is targeted to a Logical Application Model (LAM) that is independent of (a) a particular choice of cloud platform and (b) a particular choice of deployment model;
obtaining, from a user device, an Application Manifest that is agnostic to specific deployment models and target clouds, wherein the Application Manifest comprises of a specification of the logical components within the cloud application and their relationships;
combining the user-written application source code with system-generated bindings and a main file to obtain a final application source code upon receiving from the user device a deployment command that includes an identifier of the target cloud platform, wherein generic services in the user-written application code are bound to specific instances of services on the target cloud platform using the system-generated bindings;
dynamically determining, based on at least one of heuristics or user-provided preferences, the optimal deployment model for each specific component of the cloud application, wherein the optimal deployment model is selected from one of function-as-a-service (FaaS), container-as-a-service (CaaS), or Virtual-Machine-as-a-Service (VMaaS;
transforming the Application Manifest into a deployment configuration file based on the optimal deployment model and the target cloud platform, wherein logical names from the Application Manifest are consistently propagated into the deployment configuration file;
automatically generating Infrastructure-as-Code (IaC) scripts based on the deployment configuration file; and
automatically deploying, using the IaC scripts, executable components of the cloud application on the target cloud platform, wherein the executable components are based on the final application source code, the system-generated bindings, and the main file.

16. The non-transitory computer readable storage medium storing a sequence of instructions of claim 15, wherein the deployment configuration file comprises deployment artifacts that include at least one of a FaaS function, a CaaS container or a VMaaS virtual machine.

17. The non-transitory computer readable storage medium storing a sequence of instructions of claim 16, wherein the deployment artifacts further include an instantiation of at least one of (a) an object store, (b) a database or (c) a queue used by the final application source code.

18. The non-transitory computer readable storage medium storing a sequence of instructions of claim 17, wherein the instantiation includes credentials defined in the deployment configuration.

19. The non-transitory computer readable storage medium storing a sequence of instructions of claim 16, further comprising mapping and routing calls to application endpoints specified in the Application Manifest to specific functions that implement the user-written application source code for the application endpoints based on the main file, wherein the mapping further comprises associating HTTP methods and paths with API Gateway routes in the deployment configuration file.

20. The non-transitory computer readable storage medium storing a sequence of instructions of claim 15, wherein the executables components are generated by compiling the final application source code, the system-generated bindings, and the main file.
